(19) United States
(12) Patent Application Publication
(10) Pub. No.: US 2023/0297978 A1
(43) Pub. Date: Sep. 21, 2023

(54) AN INSTANT CROSS-BORDER ELECTRONIC TOKENISED GIFTING SYSTEM

(71) Applicant: ONNI PTY LTD, Brisbane (AU)

(72) Inventor: Julanne McCAPPIN, Brisbane (AU)

(21) Appl. No.: 18/018,710

(22) PCT Filed: Jul. 30, 2021
(86) PCT No.: PCT/AU2021/050830

§ 371 Date: Jan. 30, 2023

(30) Foreign Application Priority Data
Jul. 30, 2020 (AU) 2020902675

(51) Int. Cl. G06Q 20/10; G06Q 20/38

(52) U.S. Cl. CPC G06Q 20/10; G06Q 20/3821; G06Q 2220/00

(57) ABSTRACT

An electronic instant tokenised gifting method including at least one server, the electronic instant tokenised gifting method including steps of: a) providing an electronic interface associated with an instant cross-border electronic tokenised gifting system on an electronic device associated with a gifter; b) associating one or more payment credentials of the gifter with an instant cross-border electronic tokenised gifting system account associated with the gifter using the electronic interface; and c) transferring, with the instant cross-border electronic tokenised gifting system, funds from the one or more payment credentials to one or more giftees, wherein the funds are received in the form of a tokenised gift, and wherein a monetary value of the tokenised gift is approximately equal to an average value of the tokenised gift in a geographic location of the one or more giftees.

The present invention relates to an instant cross-border instant cross-border electronic tokenised gifting system and method. In particular, the present invention relates to an instant cross-border electronic tokenised gifting system and method for instantaneous cross-border tokenised gifting.

### BACKGROUND

Online and digital payment systems have become an increasingly popular way in which to pay for purchases, and especially online purchases. A variety of online payment systems exist, such as basic (and less secure) systems in which a user enters the details of a payment credential (such as a credit card) into an online form associated with a vendor.

More sophisticated systems exist in which a user associates a payment credential with an app downloaded to a mobile device (such as a mobile telephone or computing tablet). The app can then be used to make purchases that are charged to the payment credential.

However, in essence all these systems do is simplify the manner in which a transaction between a vendor and a customer is made. These systems generally do not allow a user to transfer money to third parties, and an account with a financial institution is typically still required for this. Further, even in systems that may allow payments to third parties, the third party simply received a monetary payment. There is no ability in these systems to send third parties money in the form of a tokenised gift.

Thus, there would be an advantage if it were possible to provide an electronic system that allowed a user the ability to perform transactions wherein money is received by the recipient in the form of a tokenised gift.

It will be clearly understood that, if a prior art publication is referred to herein, this reference does not constitute an admission that the publication forms part of the common general knowledge in the art in Australia or in any other country.

### SUMMARY OF INVENTION

The present invention is directed to an instant cross-border electronic tokenised gifting system and method, which may at least partially overcome at least one of the abovementioned disadvantages or provide the consumer with a useful or commercial choice.

With the foregoing in view, the present invention in one form, resides broadly in an electronic instant tokenised gifting method including at least one server, the electronic instant tokenised gifting method comprising the steps of:
a) Providing an electronic interface associated with an instant cross-border electronic tokenised gifting system on an electronic device associated with a gifter;
b) Associating one or more payment credentials of the gifter with an instant cross-border electronic tokenised gifting system account associated with the gifter using the electronic interface; and
c) Transferring, with the instant cross-border electronic tokenised gifting system, funds from the one or more payment credentials to one or more giftees, wherein the funds are received in the form of a tokenised gift, and wherein a monetary value of the tokenised gift is approximately equal to an average value of the tokenised gift in a geographic location of the one or more giftees.

The electronic device may be of any suitable form. For instance, the electronic device may comprise a desktop computer or server. Alternatively, the electronic device may be a portable electronic device, such as a mobile telephone, a computing tablet, a smart watch and the like. In this embodiment of the invention, the instant cross-border electronic tokenised gifting system may be operated or housed on the electronic device. Alternatively, the gifter may access the electronic interface associated with the instant cross-border electronic tokenised gifting system through, for instance, a website or an electronic application downloaded to the electronic device. Thus, in this embodiment of the invention, it is envisaged that the instant cross-border electronic tokenised gifting system may be housed on one or more servers.

The gifter may be any suitable entity. For instance, the gifter may be an individual, a group of two or more individuals, a corporate entity, a group of two or more corporate entities, a trust, a partnership or the like. Similarly, the one or more giftees may be of any suitable form. For instance, the one or more giftees may be individuals, a group of two or more individuals, a corporate entity, a group of two or more corporate entities, a trust, a partnership or the like. In a particular embodiment of the invention, the one or more giftees may be a charity or creative artist.

The instant cross-border electronic tokenised gifting system preferably includes a plurality of electronic interfaces with which the gifter may interact. The instant cross-border electronic tokenised gifting system may be open to any gifter to access without registration. More preferably, however, the instant cross-border electronic tokenised gifting system may require a gifter to open an account with the instant cross-border electronic tokenised gifting system before being provided with access to the instant cross-border electronic tokenised gifting system. Preferably, registration may be automated using the instant cross-border electronic tokenised gifting system (for instance using an app or a website on which the instant cross-border electronic tokenised gifting system is provided).

In embodiments of the invention in which registration is automated, registration of a gifter may be limited to gifters that can supply one or more predetermined pieces of information. For instance, a gifter may need to supply one or more pieces of information such as name, date of birth, email address or physical address. In addition, a gifter will be required to associate one or more payment credentials (financial institution account, credit or debit card, an account with an online payment system, a gift card, or any other account in which money may be withdrawn or deposited) so that funds may be transferred from the payment credential to the gifter's account in the instant cross-border electronic tokenised gifting system.

The payment credential may be registered by, for instance, entering the name of the financial institution, the branch number, the account number, the credit or debit card number, the expiry date of the credit or debit card, the name of the holder or the like, or any suitable combination thereof.

It is envisaged that, once the gifter has entered the required information into the registration interface, the electronic sales system may access one or more electronic databases to verify that the information supplied by the gifter is valid. In some embodiments, the electronic database may be databases maintained externally to the instant cross-border electronic tokenised gifting system, such as an electronic database maintained by a government authority (such as a government authority that issues motor vehicle licenses, an authority that maintains company and business registrations and the like), a financial institution (including banks, building societies, credit unions, credit card issuers and the like), a telephone directory, electoral roll or the like, or any suitable combination thereof. In some embodiments of the invention, the instant cross-border electronic tokenised gifting system may charge an amount of money against a credit or debit card in order to test the validity of the card details.

If the instant cross-border electronic tokenised gifting system is unable to verify that the information supplied by the gifter is valid, the gifter's application for registration may be refused. Alternatively, if the instant cross-border electronic tokenised gifting system is able to verify that the information supplied by the gifter is valid, the gifter's registration may be accepted.

The gifter may amend or cancel their account with the instant cross-border electronic tokenised gifting system as required. In other embodiments, the instant cross-border electronic tokenised gifting system may cancel a gifter's account under certain circumstances. For instance, the instant cross-border electronic tokenised gifting system may cancel an account in the event of fraudulent activity and so on.

It is envisaged that the instant cross-border electronic tokenised gifting system may include one or more electronic registration interfaces via which a gifter may complete the registration process. It is envisaged that the one or more electronic registration interfaces may be configured to allow a gifter to enter the information required to complete the registration process.

In order to transfer funds from the payment credential of the gifter to the giftee, the funds may be deposited in the gifter's instant cross-border electronic tokenised gifting system account. Funds may be deposited to the instant cross-border electronic tokenised gifting system account in any suitable manner. For instance, funds may be transferred from at least one of the one or more payment credentials to the gifter's instant cross-border electronic tokenised gifting system account. Alternatively, the funds to be transferred may be transferred by the instant cross-border electronic tokenised gifting system from the payment credential of the gifter to the instant cross-border electronic tokenised gifting system account of the giftee. In this embodiment, it is envisaged that the funds will not pass through the instant cross-border electronic tokenised gifting system account of the gifter during the transaction.

Funds may be transferred using any suitable technique. For instance, funds may be transferred via the financial institution that issued the payment credential. In this embodiment, a gifter may transfer funds via an app or website maintained by the financial institution or in person at a branch or automatic teller machine (ATM) of the financial institution. Alternatively, the gifter may transfer funds via a money wiring service. More preferably, however, the gifter may transfer funds from the payment credential to the instant cross-border electronic tokenised gifting system using the instant cross-border electronic tokenised gifting system.

In embodiments in which funds are deposited into the instant cross-border electronic tokenised gifting system account of the gifter, it is envisaged that the instant cross-border electronic tokenised gifting system may include one or more funds addition interfaces. Preferably, the one or more funds addition interfaces allow the gifter to select one or more of the payment credentials associated with the instant cross-border electronic tokenised gifting system from which to transfer funds to the gifter's instant cross-border electronic tokenised gifting system account. In some embodiments of the invention, the transfer of funds from the gifter's payment credential to the instant cross-border electronic tokenised gifting system may be performed via a third party payment or transaction system or platform. In other embodiments, the funds may be transferred directly from the payment credential of the gifter to the instant cross-border electronic tokenised gifting system account of the giftee via the instant cross-border electronic tokenised gifting system.

In a preferred embodiment, the instant cross-border electronic tokenised gifting system may allow the gifter to adjust the monetary value of the funds transferred to the giftee to be more or less than the average value of the tokenised gift in the geographic location of the one or more giftees

In other embodiments, funds may be deposited into the instant cross-border electronic tokenised gifting system account in the form of credits received from one or more gifters. Thus, it is envisaged that a gifter could use credits received in the instant cross-border electronic tokenised gifting system account from another gifter to send a tokenised gift to a giftee.

Funds transferred by the gifter from the one or more payment credentials to the instant cross-border electronic tokenised gifting system account may be credited to the gifter's instant cross-border electronic tokenised gifting system account instantaneously. In particular, it is envisaged that the funds may be transferred from the gifter's payment credential to the instant cross-border electronic tokenised gifting system account associated with the giftee substantially instantaneously.

In a preferred embodiment of the invention, the gifter may not be required to maintain a minimum balance in the gifter's instant cross-border electronic tokenised gifting system account. The gifter could, if desired, maintain a positive balance of funds within their instant cross-border electronic tokenised gifting system account. In this embodiment, it is envisaged that the funds may only remain in the gifter's instant cross-border electronic tokenised gifting system account for a short space of time

As previously stated, the method of the present invention includes the step of transferring, with the instant cross-border electronic tokenised gifting system, the funds from the payment credential associated with the gifter to one or more giftees, wherein the funds are received in the form of a tokenised gift. It will be understood that the term “tokenised gift” may mean that, while the giftee's account is credited with funds transferred by the gifter, the giftee is not made aware of the monetary value of the funds. Instead, the giftee may be provided with one or more credits to purchase goods and services to the approximate value of the funds transferred. It is envisaged, therefore, that the transfer of funds by the gifter may be performed as a gift to the giftee.

In an alternative embodiment, the term “tokenised gift” may simply refer to the fact that the funds transferred to the giftee are approximately equal to the value of a specific item being gifted by the gifter to the giftee. However, the monetary value of the funds transferred to the giftee may be visible to the giftee.

In a preferred embodiment of the invention, it is envisaged that a credit received by the giftee may have a fixed monetary value. Any suitable monetary value may be used, although it is envisaged that the monetary value may be relatively low. In addition, the monetary value of a credit may be determined by the geographical location in which the giftee receives the tokenised gift. For instance, a credit may have a fixed value of 1 Australian cent in Australia, 1 US cent in the United States, 1 euro cent in the relevant European countries, 1 penny in the United Kingdom and so on. Thus, it is envisaged that the balance a giftee has in their account may change (based on currency exchange rates) if the giftee travels between countries using different currencies. In an alternative embodiment of the invention, the balance in the giftee's account may be provided as a monetary value (preferably in the currency used in the giftee's geographical location) so that the giftee is aware of the value of funds that have been gifted. Thus, the terms “credit” or “credits” may refer to funds held in a giftee's account and/or transferred by the gifter or may refer to an arbitrary tokenised value given to the funds that is configured to disguise the monetary value of a gift from the giftee.

In a preferred embodiment of the invention, the tokenised gift may be received by the giftee substantially instantaneously. Thus, regardless of the relative locations of the gifter and the giftee, the tokenised gift may be received by the giftee as soon as the gifter confirms the transfer. It is envisaged that the substantially instantaneous receipt of the tokenised gift may occur regardless of the geographical location of the gifter and the giftee. In this way, the giftee may spend credits received as soon as they are transferred by the gifter.

As previously stated, in a preferred embodiment the tokenised gift may be received by the giftee substantially instantaneously. In some embodiments of the invention, the credits gifted by the gifter may be instantaneously delivered to the giftee's account. In other embodiments of the invention, the giftee may receive the tokenised gift instantaneously (in that the giftee may be made aware that they have received a tokenised gift from a gifter) but the credits associated with the tokenised gift may be retained by the electronic tokenised gifting system. In particular, the credits associated with the tokenised gift may be retained in an account associated with the electronic tokenised gifting system. More specifically, the credits associated with the tokenised gift may be retained in an escrow account associated with the electronic tokenised gifting system, and preferably may be retained until the giftee accepts or redeems the gift.

It is envisaged that, in embodiments of the invention in which the credits associated with tokenised gifts may be retained in an account associated with the electronic tokenised gifting system, it is envisaged that the electronic tokenised gifting system may comprise one or more electronic ledgers. It is envisaged that the one or more electronic ledgers may be configured to track and/or control movement of credits into and out of the account associated with the electronic tokenised gifting system.

In embodiments of the invention in which the credits associated with the tokenised gift may be retained by the electronic tokenised gifting system, it is envisaged that the credits may be transferred to the account of the giftee at any suitable time. Preferably, however, the credits may be transferred to the account of the giftee when the giftee accepts the gift or uses the credits to make a purchase via the electronic tokenised gifting system.

It is envisaged that, in certain circumstances, the credits associated with a tokenised gift may be immediately transferred to the giftee's account with the tokenised gifting system. Any suitable criteria may be applied to determine which giftees may receive the credits associated with the tokenised gift immediately. However, in a particular embodiment of the invention, the credits associated with the tokenised gift may be immediately transferred to the giftee's account if, for example, the giftee is a charity, a creative artist, a low-income earner or the like.

If a giftee has an instant cross-border electronic tokenised gifting system account, it is envisaged that the funds transferred by the gifter may be received in the giftee's instant cross-border electronic tokenised gifting system account in the form of a tokenised gift. Alternatively, if a giftee does not have an instant cross-border electronic tokenised gifting system account, the instant cross-border electronic tokenised gifting system may notify the giftee (for instance, by SMS message, MMS message, email, push notification or the like) of the receipt of a tokenised gift. In this embodiment, it is envisaged that the giftee may be required to create an instant cross-border electronic tokenised gifting system account in order to access the tokenised gift. In a preferred embodiment, the giftee may receive an image (photograph, drawing, emoji, or the like) of the item or service that has been gifted by the gifter. The image may comprise the notification or may comprise part of the notification.

In a preferred embodiment of the invention, the gifter may transfer credits relating to the purchase of a specific item or service. For example, the instant cross-border electronic tokenised gifting system may allow a gifter to select a specific item (a drink, food item, transport fare, object and the like) and transfer sufficient credits to the giftee to pay for the purchase of the item. In further embodiments of the invention, the instant cross-border electronic tokenised gifting system may allow a gifter to select a specific item (a drink, food item, transport fare, object and the like) and transfer sufficient credits to the giftee's instant cross-border electronic tokenised gifting system account to pay for the purchase of the item. In other embodiments of the invention, the gifter may choose or nominate a monetary value to be transferred to the giftee. In this embodiment of the invention, it is envisaged that the instant cross-border electronic tokenised gifting system may then provide the gifter with a selection of gifts that may be purchased by the giftee for the chosen or nominated monetary value (preferably, taking into consideration the geographic location of the giftee). The gifter may then select a gift to send to the giftee and the chosen or nominated monetary value may then be transferred to the giftee in the form of the tokenised gift.

In some embodiments of the invention, the instant cross-border electronic tokenised gifting system may be configured to allow a gifter to send multiple gifts simultaneously. The multiple gifts may be sent to the same giftee or two or more giftees. The multiple gifts may be of the same type, or may be of different types.

It is envisaged that the giftee may receive a notification generated by the instant cross-border electronic tokenised gifting system to inform the giftee of the receipt of the tokenised gift. Any suitable notification may be received, such as a text message, email notification, voicemail message, push notification, sound notification, vibration notification and the like, or any suitable combination thereof.

It will be understood that the price of goods and services may vary. Variation in price may occur between merchants or between geographic locations (cities, states or countries). Preferably, the instant cross-border electronic tokenised gifting system may be configured to determine the giftee's geographical location via information obtained from the giftee's instant cross-border electronic tokenised gifting system account (such as the location of recent transactions, the giftee's registration information, GPS information and so on). It is envisaged that, upon determining the giftee's location, the instant cross-border electronic tokenised gifting system may transfer sufficient credits to purchase the item or service in the giftee's location. It is envisaged that, if a giftee travels to a country that uses a different currency to the one at their usual or home location (for instance, the location at which, or to which, the giftee's account is registered) the instant cross-border electronic tokenised gifting system may convert the giftee's number of credits the giftee has in their usual currency to the number of credits the giftee has at their new locations based on currency exchange rates. As a specific example, and based on current exchange rates, a giftee's 100 credits in the United States may be converted to between approximately 140 and 150 credits if the giftee travels to Australia.

It is envisaged that the instant cross-border electronic tokenised gifting system may transfer credits for the purchase of an item or service based on an average price of the item or service in the giftee's location. In embodiments of the invention in which the gifter and the giftee are located in different countries, the transferred credits may be converted from the currency used in the gifter's location to the currency used in the giftee's location by the instant cross-border electronic tokenised gifting system. Thus, it is envisaged that the instant cross-border electronic tokenised gifting system may be used in any geographical location, regardless of the location of the gifter and the giftee.

In one embodiment of the invention, prior to the transfer of the tokenised gift to the giftee, the method of the present invention may include the step of determining the monetary value of the tokenised gift. The monetary value of the tokenised gift (and therefore the number of credits transferred to the giftee) may be determined using any suitable technique. However, it is envisaged that determining the value of the tokenised gift may comprise the following steps:
Determining the geographic location of the giftee;
Determining a price of the tokenised gift in the geographic location of the giftee;
Converting the price of the tokenised gift in the geographic location of the giftee to a monetary value in the geographic location of the gifter; and
Transferring the monetary value to the giftee in the form of credits associated with the electronic tokenised gifting system.

The electronic tokenised gifting system may determine the geographic location of the giftee using any suitable technique. For example, the electronic tokenised gifting system may interrogate an electronic database or ledger associated with the electronic tokenised gifting system to determine the location of the giftee's recent transactions using the electronic tokenised gifting system. The electronic tokenised gifting system may also interrogate one or more additional information sources that may be internal or external to the electronic tokenised gifting system. For example, the electronic tokenised gifting system may interrogate an electronic database or ledger associated with a financial institution (such as the financial institution associated with the giftee's payment credential registered with the electronic tokenised gifting system) to determine the current geographic location of the giftee. In other embodiments of the invention, the electronic tokenised gifting system may include GPS functionality that enables the electronic tokenised gifting system to determine the geographic location of the giftee. Alternatively, the electronic tokenised gifting system may access the GPS functionality of the giftee's electronic device (mobile telephone, computing tablet, smart watch or the like). In other embodiments, a giftee may elect to enter their current geographic location into the electronic tokenised gifting system. In still further embodiments of the invention, the electronic tokenised gifting system may determine the geographic location of the giftee using cell phone triangulation.

The electronic tokenised gifting system may determine a price of the tokenised gift in the geographic location of the giftee using any suitable technique. The price may be any suitable price. For instance, the price may be an average price, a higher-than-average price or a lower-than-average price.

It is envisaged that the price may be determined based on one or more pieces of information. Any suitable pieces of information may be used, such as average income in the geographic location, inflation/consumer price indices in the geographic location and so on, or any suitable combination thereof. It is envisaged that the electronic tokenised gifting system may interrogate one or more internal or external databases in order to determine the one or more pieces of information.

The electronic tokenised gifting system may update price information based on new pieces of information at any suitable frequency. For instance, the price information may be updated at regular or irregular time intervals. Alternatively, the price information may be updated on an ad-hoc basis, such as when a tokenised gift is to be sent to a particular geographic location.

In some embodiments of the invention, the electronic tokenised gifting system may comprise one or more machine learning modules configured to track changes in the price of the tokenised gift at one or more geographic locations over time and to predict future changes to the price. Predictions of changes in the price of the tokenised gift may be made using any suitable technique. However, it is envisaged that the predictions may be made based on one or more of the following: short-term price trends, long-term prices trends, economic data relating to the geographic location, commodity and agricultural prices, shipping and transportation prices and the like, or any suitable combination thereof.

The electronic tokenised gifting system may convert the price of the tokenised gift in the geographic location of the giftee to a monetary value in the geographic location of the gifter using any suitable technique. Typically, however, the price may be converted based on currency conversion rates, and preferably current currency conversion rates, although it is envisaged that the conversion may be based on trends in conversion rates rather than spot prices. In some embodiments of the invention, the electronic tokenised gifting system may interrogate one or more external electronic databases, such as external electronic databases maintained by financial institutions and the like.

Once the monetary value of the tokenised gift is determined by the electronic tokenised gifting system, the monetary value of the tokenised gift may be transferred to the giftee in the form of credits.

In some embodiments of the invention, electronic tokenised gifting system may include multiple accounts in which funds may be maintained. In this embodiment, it is envisaged that accounts may be maintained in different geographical locations. For instance, accounts may be located within different cities, provinces, states or the like within one country. Alternatively, or in addition to, accounts may be maintained in locations having different currencies to one another. In this embodiment, it is envisaged that an account may be located in each of at least a portion of the countries in which gifters and/or giftees are, or may be, located. In an alternative embodiment, a plurality of accounts may be located in the same geographic location, but the accounts may be in different currencies to one another. The multiple accounts may be financial institution accounts, although more preferably, the multiple accounts are instant cross-border electronic tokenised gifting system accounts.

Any suitable number of accounts may be maintained by the electronic tokenised gifting system. However, it is envisaged that accounts may be maintained in at least two or more locations and/or two or more currencies. For instance, the instant cross-border electronic tokenised gifting system may include an Australian dollar account (preferably located in Australia) and/or a US dollar account (preferably located in the United States) and/or a pound sterling account (preferably located in the United Kingdom) and/or a Euro account (preferably located in the Eurozone) and so on.

By maintaining accounts in different currencies (and optionally different geographic locations) it is envisaged that, when the currency used by the gifter is different to the currency used by the giftee, the instant cross-border electronic tokenised gifting system may substantially immediately transfer funds to the giftee without a delay generated by transferring funds internationally.

In a specific embodiment, the gifter may use the instant cross-border electronic tokenised gifting system to send a gift to a giftee in a geographic location in which a different currency is used in comparison to the gifter's currency. In this embodiment, the gifter transfers a quantity of funds to an account of the instant cross-border electronic tokenised gifting system that is in the same currency as the gifter's funds. The instant cross-border electronic tokenised gifting system may then determine an equivalent amount in the currency of the giftee. The instant cross-border electronic tokenised gifting system may then authorise or actuate a transfer of the equivalent amount from an account in the currency of the giftee. Thus, funds sent by the gifter may be received substantially instantaneously by the giftee.

In further embodiments of the invention, the gifter may send credits corresponding to the average price of an item or service in the giftee's location. Upon purchase of the item or service, the gifter's account may be debited the difference between the average price and the actual price (if the actual price is higher). If the price of an item is higher than the value of the credits transferred by the gifter, the giftee may be required to pay the difference between the value of the transferred credits and the actual price. If the price of an item is lower than the value of the credits transferred by the gifter, the difference may be retained in the giftee's account. In other embodiments, the amount of money deducted from the giftee's account may be rounded up (such as to the nearest 5c, 10c, 50c, dollar or the equivalent in other currencies) and the difference between the price of the item and the rounded-up value may be donated to a charity or creative artist. Preferably, the giftee may nominate one or more charities and/or creative artists to which the donation will be provided.

While the gifter may transfer credits equating to the price of a particular item or service to the giftee, it is envisaged that the giftee may not be required to spend the credits on the particular item or service. For instance, if the gifter sends a tokenised gift in the form of a cup of coffee, the giftee may instead spend the credits represented by the tokenised gift on a different item or service. In this embodiment of the invention, it is envisaged that the giftee will be aware that they have credits only to cover the price of the particular item selected by the gifter, and any difference in price between the item the giftee purchases and the item selected by the gifter will be deducted from the giftee's instant cross-border electronic tokenised gifting system account. In further embodiments of the invention, it is envisaged that if the giftee receives multiple tokenised gifts, the gifter may combine the credits represented by two or more of the tokenised gifts to purchase an item or service of higher value.

In order to purchase the tokenised gift (or to redeem the credits associated with the tokenised gift for another purpose) a merchant may also have an instant cross-border electronic tokenised gifting system account into which the giftee may transfer the credits received from the gifter for the item upon purchase. More preferably, however, the funds associated with the tokenised gift may be transferred from the instant cross-border electronic tokenised gifting system account of the giftee to a financial institution account associated with the merchant. This may be achieved using any suitable technique. For instance, the merchant may scan a code, barcode, QR code or the like on the electronic device of the giftee in order to complete the purchase. In other embodiments of the invention, the electronic tokenised gifting system may make use of a Bluetooth, Wi-Fi or similar connection to allow the giftee to transfer funds associated with the tokenised gift to an account associated with the merchant. Alternatively, the giftee may “tap” the electronic device (i.e. hold the electronic device in relatively close proximity) on an electronic payment device associated with the merchant (such as a card reader, payment terminal or the like). Thus, the electronic tokenised gifting system may make use of near field communication to allow the giftee to transfer funds associated with the tokenised gift to an account associated with the merchant. In a particular embodiment, the transfer of funds to the merchant's account may be achieved by the giftee linking the payment credentials associated with the instant cross-border electronic tokenised gifting system to a digital wallet (such as a digital wallet on the giftee's mobile telephone) and paying via a cashless transfer.

In some embodiments of the invention, it is envisaged that each transfer of credits by a gifter may include an additional payment. For instance, the instant cross-border electronic tokenised gifting system may charge a transaction fee that is added to the funds deducted from the gifter's account. In other embodiments of the invention, the credits transferred from the gifter's account may be rounded up and the difference between the rounded-up total and the credits to be transferred to the giftee may be used for another purpose, such as, but not limited to, charitable donations, donations to creative artists, schools, hospitals, fundraisers and the like. In some embodiments of the invention, the giftee can choose to round-up the total so that the difference may be used for other purpose. In this embodiment of the invention, the giftee may choose the purpose to which the difference is to be used. In other embodiments of the invention, the round-up of the total may be automatic. In this embodiment, the giftee may choose the purpose to which the difference is put, or the difference may be assigned to a purpose by the electronic tokenised gifting system.

In other embodiments of the invention, if the giftee has credits remaining in their account following the purchase of an item or service, the giftee may choose to donate at least a portion of the remaining credits. Preferably, the giftee may choose who is to receive the donation.

Any suitable round up may be applied. For instance, the round up may be to the nearest 5 cents (or the equivalent in different currencies), the nearest 10 cents (or the equivalent in different currencies), the nearest 50 cents (or the equivalent in different currencies), or the nearest dollar (or the equivalent in different currencies).

It is envisaged that the giftee may be unable to withdraw funds from their account with the instant cross-border electronic tokenised gifting system. Thus, it is envisaged that the only way in which the giftee may use the funds in their instant cross-border electronic tokenised gifting system account may be to purchase items via the instant cross-border electronic tokenised gifting system, sending gifts to other users, or donating funds.

In a preferred embodiment of the invention, the instant cross-border electronic tokenised gifting system may include one or more payment credential management interfaces. It is envisaged that, in the one or more payment credential management interfaces, a gifter may notify the instant cross-border electronic tokenised gifting system of issues relating to the payment credential. For instance, the gifter may notify the instant cross-border electronic tokenised gifting system of the loss or theft or a payment credential, of the existence of fraudulent transactions and so on.

In addition, it is envisaged that the instant cross-border electronic tokenised gifting system may allow a gifter and/or giftee to notify the instant cross-border electronic tokenised gifting system of future travel. The gifter and/or giftee may notify the instant cross-border electronic tokenised gifting system of any suitable information relating to the future travel, such as, but not limited to, the location of the travel (country, city etc.), the dates of travel and the like. The purpose of this is two-fold: it is easier for the instant cross-border electronic tokenised gifting system to identify fraudulent transactions (such as those occurring in locations in which the gifter and/or giftee is not presently located) while also ensuring the that the gifter and/or giftee's instant cross-border electronic tokenised gifting system account is not frozen or suspended due to transactions occurring in a location other than the gifter and/or giftee's normal location.

In some embodiments of the invention, the instant cross-border electronic tokenised gifting system may issue statements to users of the instant cross-border electronic tokenised gifting system. The statements may be issued on request, or at regular or irregular intervals of time.

The statements issued by the instant cross-border electronic tokenised gifting system may include any suitable information. However, it is envisaged that the statements may include a record of transactions associated with a user's account, such as credits transferred to giftees, credits received from gifters, purchases made and so on. In some embodiments of the invention, the statement may include information regarding the donating of rounded-up amounts, or similar donations. Thus, in this embodiment of the invention, it is envisaged that the statements issued by the electronic tokenised gifting system may be used for tax purposes.

In a second aspect, the invention resides broadly in an instant cross-border electronic tokenised gifting system including at least one processor and at least one non-transitory computer readable storage medium storing instructions thereon that, when executed by the at least one processor, cause the system to:
a) Receive, from an electronic device associated with a gifter, a request to transfer funds from a payment credential associated with the gifter to a giftee via the instant cross-border electronic tokenised gifting system;
b) Transfer the funds from the payment credential to an instant cross-border electronic tokenised gifting system account associated with the giftee, wherein the at least a portion of the funds is received in the form of a tokenised gift; and
c) Allow the giftee to purchase an item or service with the electronic tokenised gifting system using the funds received in the form of a tokenised gift.

In a third aspect the invention resides broadly in a third-party transaction server for transferring funds to and from an electronic tokenised gifting system, the third-party transaction server comprising:
A file server configured to receive one or more electronic funds transfers from one or more payment credentials associated with an electronic tokenised gifting system account of a gifter;
A database that associates and stores details of the one or more received electronic funds transfers in the electronic tokenised gifting system account of the gifter;
A data backend communicatively coupled to the database, the data backend managing access and retrieval of the one or more received electronic funds transfers;
A gifter interface communicatively coupled to the data backend and to a gifter client device, the gifter interface configured to transfer at least a portion of funds associated with the one or more electronic funds transfers to an electronic tokenised gifting system account of a giftee;
A giftee interface communicatively coupled to the data backend that communicates to the giftee client device the receipt of the at least a portion of funds in the form of a tokenised gift in the electronic tokenised gifting system account of the giftee; and
Wherein the giftee interface allows the recipient to make a purchase by transferring at least a portion of funds associated with the tokenised gift to an account associated with a merchant.

In a fourth aspect, the invention resides broadly in a method, in a communication environment including a third-party transaction server comprising a processor and a memory, for transferring funds to and from an electronic tokenised gifting system, the method comprising the steps of:
receiving, by the third-party transaction server, one or more electronic funds transfers from one or more payment credentials associated with an electronic tokenised gifting system account of a gifter;
generating, with the third-party transaction server, a funds transfer from the one or more payment credentials to an electronic tokenised gifting system account of a giftee;
determining, with the third-party transaction server, a monetary value of the funds transfer based on the location of the giftee;
deducting, with the third-party transaction server, the monetary value of the funds transfer from the one or more payment credentials of the gifter;
crediting in the form of a tokenised gift, with the third-party transaction server, the monetary value of the funds transfer to the electronic tokenised gifting system account of the giftee; and
communicating, with the third-party transaction server, the receipt of the tokenised gift to the giftee.

In a preferred embodiment, the gifter client device and the giftee client device comprise electronic devices such as, but not limited to, computers, mobile telephones, computing tablets, smart watches and the like.

The present invention provides numerous advantages. Firstly, the present invention provides the ability for a giftee to instantaneously receive a gift from a gifter. In addition, the present invention provides the ability to send and instantly receive gifts anywhere in the world, and regardless of the relative locations of the gifter and the giftee. Thus, the present invention allows for instant cross-border transfers of funds. In addition to this, the giftee is not restricted to using their funds only with certain vendors, and the instant cross-border electronic tokenised gifting system may be used with any vendor that accepts cashless payments. Further, the present invention allows for donations to charities and creative artists as part of a transaction with a vendor.

Any of the features described herein can be combined in any combination with any one or more of the other features described herein within the scope of the invention.

The reference to any prior art in this specification is not, and should not be taken as, an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 illustrates an electronic instant tokenised gifting method 10 according to an embodiment of the present invention.

FIGS. 2 to 9 illustrate electronic interfaces of an instant cross-border electronic tokenised gifting system according to an embodiment of the invention.

### DETAILED DESCRIPTION

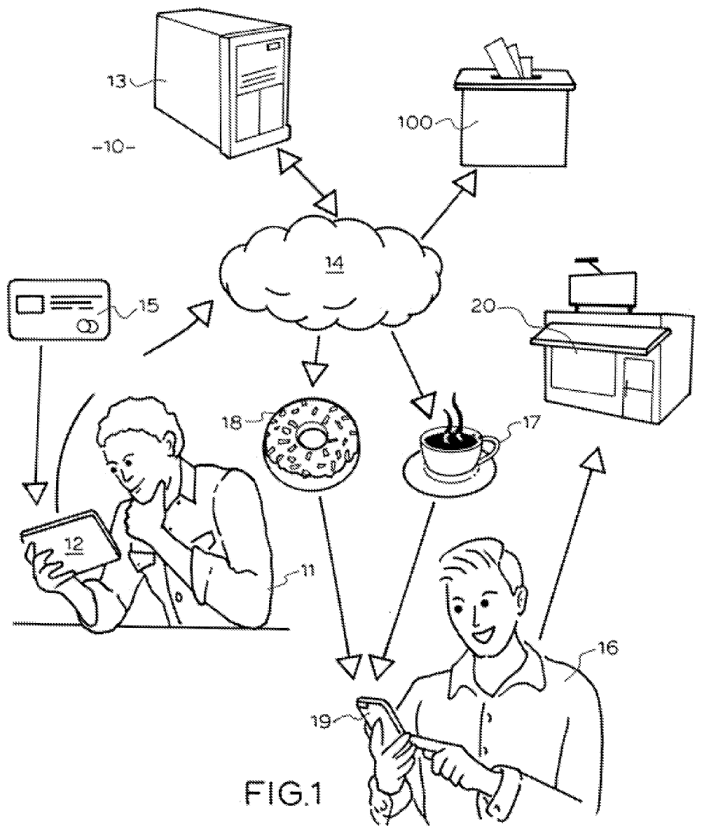

FIG. 1 illustrates an electronic instant tokenised gifting method 10 according to an embodiment of the present invention. In this Figure, a gifter 11 accesses an instant cross-border electronic tokenised gifting system on an electronic device 12 such as a mobile telephone or computer tablet. The instant cross-border electronic tokenised gifting system is located on a server 13, and the gifter 11 may gain accesses to the instant cross-border electronic tokenised gifting system from their electronic device 12 via the internet 14.

The gifter 11 has an account with the instant cross-border electronic tokenised gifting system and associates a payment credential 15 in the form of a credit card therewith.

The instant cross-border electronic tokenised gifting system allows the gifter 11 to send a tokenised gift to a giftee 16. When the gifter 11 wishes to send a tokenised gift, the gifter 11 selects the type of tokenised gift to give. For instance, the tokenised gift may be a cup of coffee 17 or a donut 18.

Once the gifter 11 selects the tokenised gift 17, 18 to be sent, the instant cross-border electronic tokenised gifting system determines the approximate (or average) cost of the tokenised gift 17, 18 in the geographic location of the giftee 16 and then deducts, via the internet 14, the funds from the account of the gifter 11 or from the gifter's payment credential 15.

Simultaneously, and substantially instantaneously, funds are sent from the instant cross-border electronic tokenised gifting system to the account of the giftee 16 via the internet. The instant cross-border electronic tokenised gifting system informs the giftee 16, via an electronic device 19 associated with the giftee 16, that credits to the approximate (or average) value of a cup of coffee 17, a donut 18 (and so on) have been received from the gifter 11 and are available for use in the giftee's account with the instant cross-border electronic tokenised gifting system.

The giftee 16 can use the credits to purchase the specific tokenised gift 17, 18 from a merchant 20. Alternatively, the giftee 16 can use the credits to purchase a different product (or service) although the giftee 16 will do so knowing that the credits sent by the gifter 11 will only have an approximate monetary value of the tokenised gift 17, 18. Thus, if the product or service that the giftee 16 chooses to purchase is of a higher monetary value than the tokenised gift 17, 18 the giftee 16 will be required to pay the difference between the value of the credits received from the gifter 11 and the chosen product or service.

In some embodiments, the instant cross-border electronic tokenised gifting system may round up the price of the produce or service purchased by the giftee 16. In this case, the money deducted from the account of the giftee 16 may be greater than the value of the produce purchased by the giftee 16. In these embodiments, it is envisaged that the instant cross-border electronic tokenised gifting system may donate the difference between the purchase price and the rounded-up value to a charity or creative artist 100.

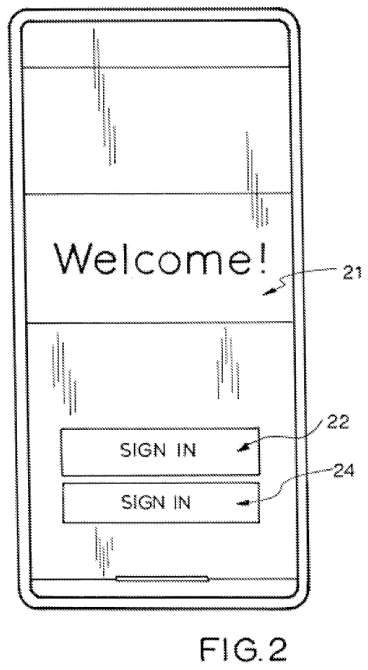

FIG. 2 illustrates an electronic interface of an instant cross-border electronic tokenised gifting system according to an embodiment of the invention. In particular, FIG. 2 illustrates a login interface 21 through which a registered user (gifter or giftee) may sign into the instant cross-border electronic tokenised gifting system by clicking the “Sign In” button or link 22. Alternatively, a new user (gifter or giftee) may register with the instant cross-border electronic tokenised gifting system by clicking on a button or link 24 marked “Sign Up”.

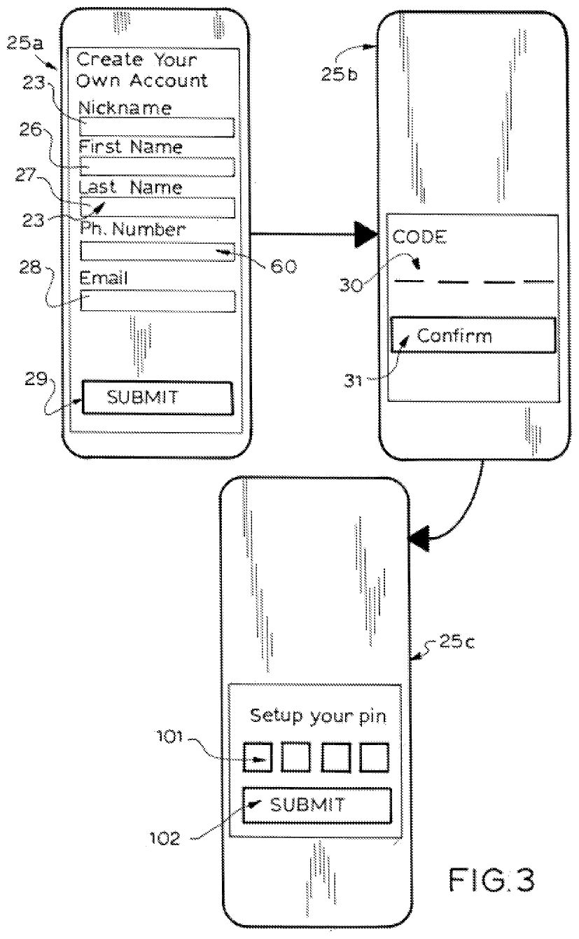

FIG. 3 illustrates electronic interfaces of an instant cross-border electronic tokenised gifting system according to an embodiment of the invention. In particular, FIG. 3 illustrates sign up interfaces 25a, 25b, 25c that are provided to allow a new user (gifter or giftee) to create an instant cross-border electronic tokenised gifting system account.

In interface 25a, a new user enters their nickname or username 23, first name 26, last name 27, email address 28 and telephone number 60. The user then presses the “Submit” button 29 to progress to interface 25b.

In interface 25b the instant cross-border electronic tokenised gifting system sends a code to the user's telephone (in the form of an SMS message, MMS message or the like). The user is required to enter the code 30 into interface 25b to verify that the telephone number provided is valid and correct. The user then presses the “Confirm” button 31 to move to the next step of the process as shown in interface 25c.

In interface 25c, once the user has successfully entered the code 30 sent to their telephone, a new user enters their personal identification number (PIN) 101 and then presses a “Submit” button 102. The user may use their PIN 101 as a login identifier once registered with the electronic tokenised gifting system.

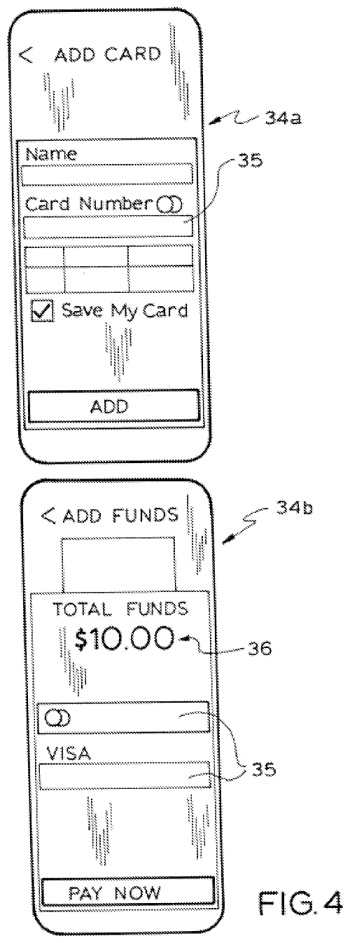

FIG. 4 illustrates electronic interfaces of an instant cross-border electronic tokenised gifting system according to an embodiment of the invention. In particular, FIG. 4 illustrates payment credential registration interfaces 34a, 34b that are provided to allow a new user (gifter or giftee) to link a payment credential to their instant cross-border electronic tokenised gifting system account.

In interface 34a, a user enters their credit card details 35. In interface 34b, a user is provided with a list of the credit cards 35 that they have registered with the electronic tokenised gifting system. The user then selects a sum of money 36 that they would like to add to their account with the electronic tokenised gifting system, as well as the credit card 35 from which the sum of money 36 will be deducted.

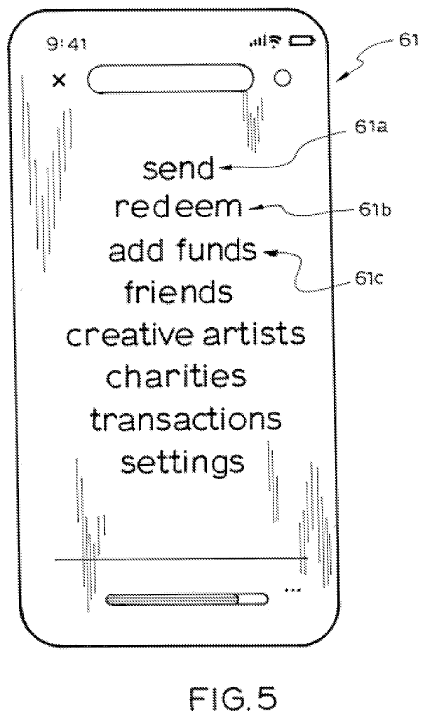

FIG. 5 illustrates a home interface 61 of an instant cross-border electronic tokenised gifting system. From the home interface 61, a user can select multiple functions, such as sending credits 61a, redeeming credits received from others 61b, adding funds 61c from a payment credential and so on.

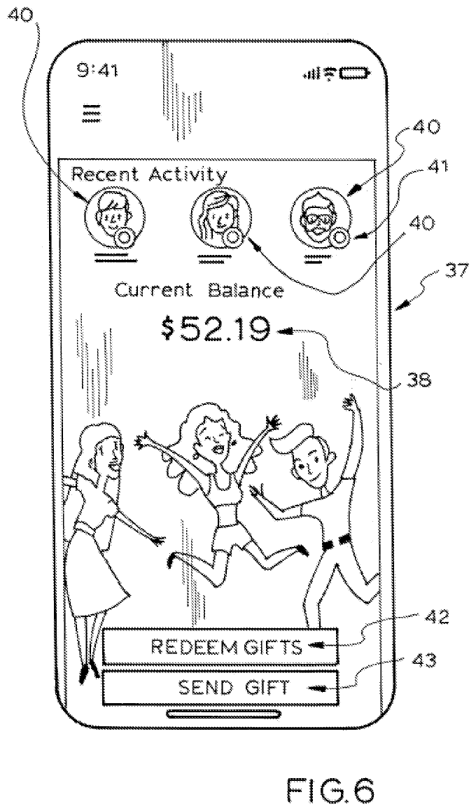

FIG. 6 illustrates an electronic interface of an instant cross-border electronic tokenised gifting system according to an embodiment of the invention. In particular, FIG. 6 illustrates a dashboard interface 37. The dashboard interface 37 displays to a user the sum of money 38 in their account.

The dashboard interface 37 also displays a user's recent activity in the instant cross-border electronic tokenised gifting system. In the embodiment illustrated in FIG. 6, it may be seen that the user has acted as a gifter and has sent funds to the approximate value of a donut 41 to each of a plurality of giftees 40.

In the dashboard interface 37, the user has the option of redeeming a gift (i.e. using some or all of the money 38 in their account) by pressing the “Redeem Gift” button 42. Alternatively, the user can elect to send a gift (either using the money 38 in their account, or using money deducted from a payment credential) by pressing the “Send Gift” button 43.

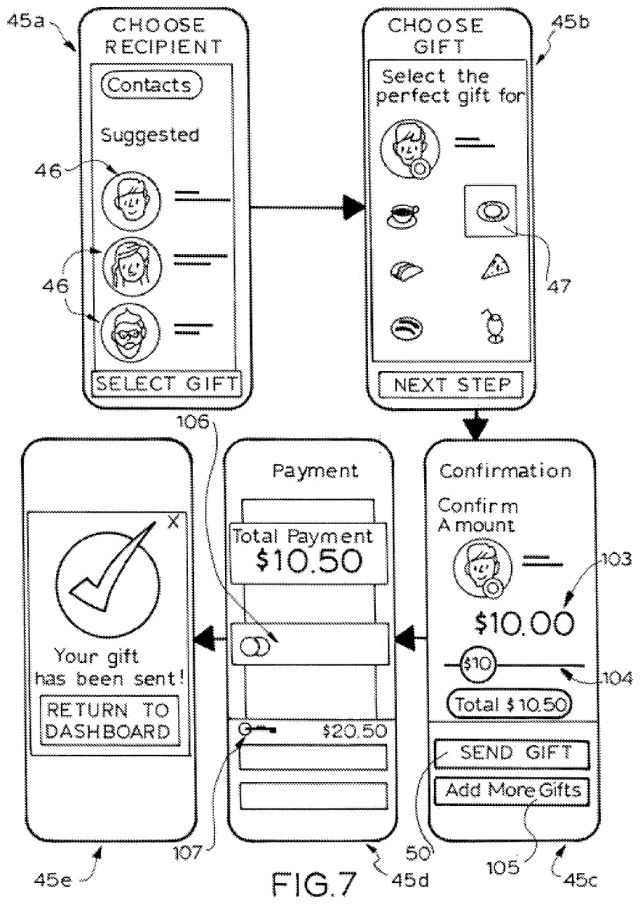

FIG. 7 illustrates electronic interfaces of an instant cross-border electronic tokenised gifting system according to an embodiment of the invention. In particular, FIG. 7 illustrates gift sending interfaces 45a, 45b, 45c, 45d, 45e.

When a gifter wishes to send a tokenised gift, the gifter selects one or more giftees to receive the tokenised gift from a list of giftees 46 in gift sending interface 45a. Once the giftee 46 (or group of giftees) is selected, the gifter selects the tokenised gift 47 to be sent to the giftee in gift sending interface 45b.

Once the tokenised gift 47 is selected, gift sending interface 45c informs the user of the average price 103 of the tokenised gift 47 in the geographic location of the giftee. The gifter may choose to transfer the average price of the tokenised gift to the giftee, or may choose a different monetary value to be sent to the giftee (and deducted from the gifter's account). The selection of the amount of money to be sent to the giftee is made by sliding slide bar 104 to increase or decrease the amount of money to be sent.

Once the user is satisfied with the monetary value to be transferred, the user may choose a payment credential from which the monetary value will be deducted. As shown in interface 45d, the user may choose to deduct funds from a credit card 106 or from a balance 107 in the user's instant cross-border electronic tokenised gifting system.

Once the gifter has chosen how much money to send, the gifter then presses the “Send Gift” button 50, and gift sending interface 45e is displayed on the electronic device of the gifter confirming that the giftee has been sent the tokenised gift. Before sending the gift, the user may also elect to send additional gifts at the same time by pressing the “Add More Gifts” button 105.

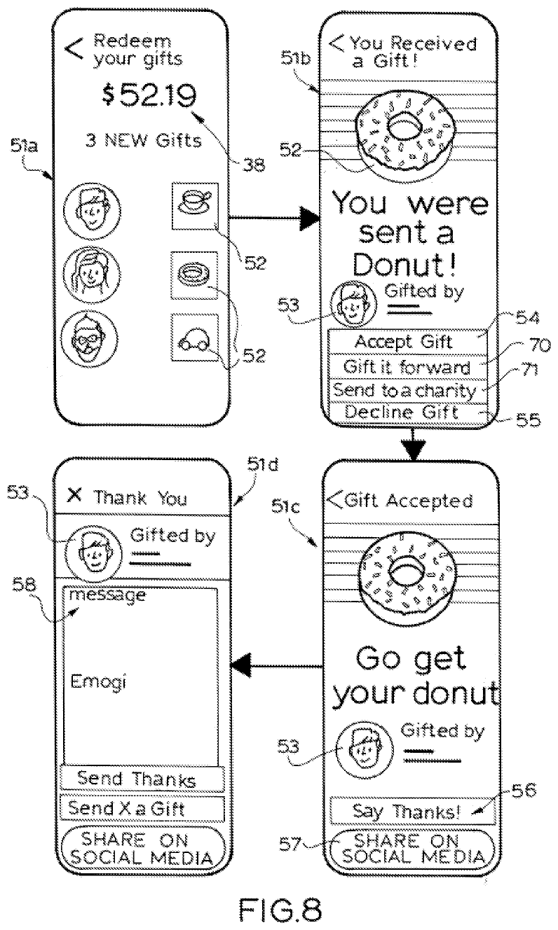

FIG. 8 illustrates electronic interfaces of an instant cross-border electronic tokenised gifting system according to an embodiment of the invention. In particular, FIG. 8 illustrates gift receiving interfaces 51a, 51b, 51c, 51d.

In interface 51a, a list of gifts 52 that have been sent to the giftee are displayed. The giftee may select multiple gifts to accept at once or may select an individual gift to accept, as seen in interface 51b. The total monetary value 38 of the gifts 52 is also displayed in interface 51a.

Interface 51b illustrates a notification that a tokenised gift 52 (in the form of funds to the approximate value of a donut in the giftee's geographic location) has been received from the gifter 53. The giftee can elect to accept 54 the tokenised gift 52 or decline 55 the tokenised gift 52. Alternatively, the giftee could elect to forward 70 the credits associated with the tokenised gift 52 to another user or donate 71 the credits to a charity. The notification displayed in interface 51b is received by the giftee substantially instantaneously as the sending of the funds by the gifter 53.

If the giftee accepts the tokenised gift 52, the giftee is notified via interface 51c of the availability of funds to the approximate value of the tokenised gift 52. The giftee is then able to spend the funds. Optionally, the giftee may choose to thank 56 the gifter 53 or share 57 the receipt of the tokenised gift 52 via one or more social media platforms.

If the giftee elects to thank 56 the gifter 53, interface 51d is displayed allowing the giftee to send a message 58 to the gifter 53 via the instant cross-border electronic tokenised gifting system.

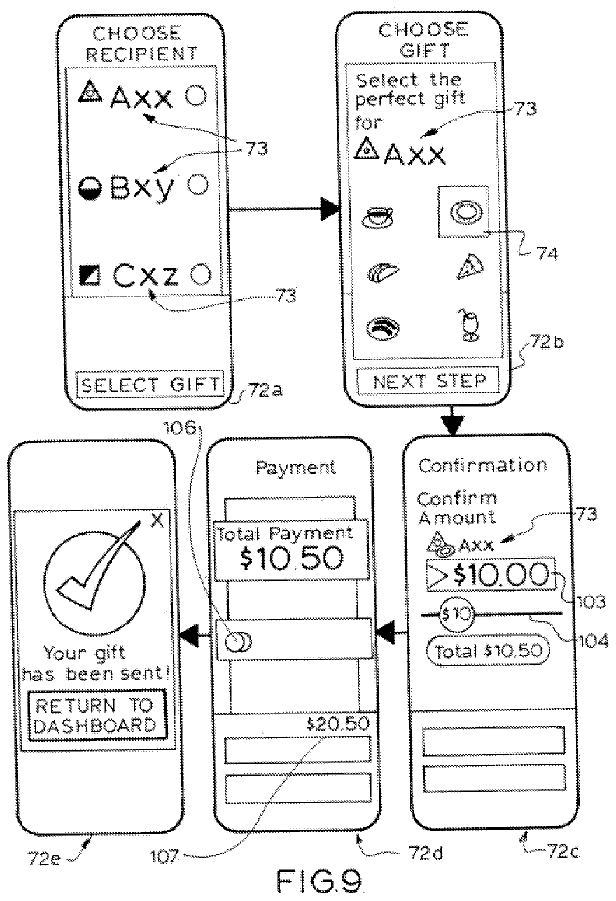

FIG. 9 illustrates electronic interfaces of an instant cross-border electronic tokenised gifting system according to an embodiment of the invention. In particular, FIG. 9 illustrates donation interfaces 72a, 72b, 72c, 72d, 72e.

In interface 72a, a user of the instant cross-border electronic tokenised gifting system may choose a charity 73 to which they wish to make a donation. The charities 73 may be ones that the user has chosen as their preferred charities to which to donate, or may be a full list of all charities that are members of the instant cross-border electronic tokenised gifting system.

Once the user has selected the charity 73 to which they wish to donate, the user may select a gift 74 to donate to the charity 73, as shown in interface 72b. Once the gift 74 is chosen, interface 72c is displayed. In this interface 72c, the user may adjust the monetary value 103 to be donated to the charity 73 by sliding slider bar 104 to increase or decrease the amount of money 103 to be donated. It will be understood that, in this instance, the user is not donating the gift 74 to the charity, but is instead donating the monetary value 75 associated with the gift 74.

Once the user is satisfied with the monetary value to be donated, the user may choose a payment credential from which the monetary value will be deducted. As shown in interface 72d, the user may choose to deduct funds from a credit card 106 or from a balance 107 in the user's instant cross-border electronic tokenised gifting system.

Once the donation has been made, interface 72e is displayed confirming the transfer of the donation to the charity.

It will be understood that donations to creative artists may be performed in much the same manner as that shown in FIG. 9.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. An electronic instant tokenised gifting method including at least one server, the electronic instant tokenised gifting method comprising the steps of:
a. roviding an electronic interface associated with an instant cross-border electronic tokenised gifting system on an electronic device associated with a gifter;
b. associating one or more payment credentials of the gifter with an instant cross-border electronic tokenised gifting system account associated with the gifter using the electronic interface; and
c. transferring, with the instant cross-border electronic tokenised gifting system, funds from the one or more payment credentials to one or more giftees, wherein the funds are received in the form of a tokenised gift, and wherein a monetary value of the tokenised gift is approximately equal to an average value of the tokenised gift in a geographic location of the one or more giftees.

2. The electronic instant tokenised gifting method according to claim 1, wherein the instant cross-border electronic tokenised gifting system is housed on one or more servers.

3. The electronic instant tokenised gifting method according to claim 2 wherein the gifter accesses the electronic interface associated with the instant cross-border electronic tokenised gifting system through a website or an electronic application downloaded to the electronic device.

4. The electronic instant tokenised gifting method according to claim 3, wherein the electronic device comprises a computer, mobile telephone, computing tablet or smart watch.

5. The electronic instant tokenised gifting method according to claim 4, wherein the one or more payment credentials comprise a financial institution account, a credit or debit card, an account with an online payment system, a gift card, or any other account in which money is withdrawn or deposited.

6. The electronic instant tokenised gifting method according to any one of the preceding claim 5, wherein the funds transferred by the gifter from the one or more payment credentials to the instant cross-border electronic tokenised gifting system account associated with the gifter may be credited to the instant cross-border electronic tokenised gifting system account associated with the gifter instantaneously.

7. The electronic instant tokenised gifting method according to claim 6, wherein the tokenised gift is provided to the giftee in the form of a credit to purchase goods and services to the approximate value of the funds transferred.

8. The electronic instant tokenised gifting method according to claim 7 wherein the monetary value of the credit is determined by the geographical location in which the giftee received the tokenised gift.

9. The electronic instant tokenised gifting method according to claim 8, wherein the tokenised gift is received by the giftee as soon as the gifter confirms the transfer of the at least a portion of the funds.

10. The electronic instant tokenised gifting method according to claim 9, wherein the tokenised gift is received is an instant cross-border electronic tokenised gifting system account associated with the giftee.

11. The electronic is instant tokenised gifting method according to claim 6, wherein the one or more credits transferred by the gifter relate to the purchase of a specific item or service.

12. The electronic instant tokenised gifting method according to claim 11 wherein, upon receipt of the tokenised gift, the giftee receives an image of the item or the service.

13. The electronic instant tokenised gifting method according to claim 12, wherein the image is an emoji.

14. The electronic instant tokenised gifting method according to claim 13, wherein, if the giftee receives two or more tokenised gifts, the giftee is able to combine the credits represented by the two or more of the tokenised gifts to purchase an item or service of higher value than the specific item or service.

15. The electronic instant tokenised gifting method according to claim 14, wherein the instant cross-border electronic tokenised gifting system allows the gifter and/or the giftee to notify the instant cross-border electronic tokenised gifting system of future travel.

16. The electronic instant tokenised gifting method according to claim 15, wherein the instant cross-border electronic tokenised gifting system allows the gifter to adjust the monetary value of the funds transferred to the giftee to be more or less than the average value of the tokenised gift in the geographic location of the one or more giftees.

17. An instant cross-border electronic tokenised gifting system including at least one processor and at least one non-transitory computer readable storage medium storing instructions thereon that, when executed by the at least one processor, cause the system to:
a. receive, from an electronic device associated with a gifter, a request to transfer funds from a payment credential associated with the gifter to a giftee via the instant cross-border electronic tokenised gifting system;
b. transfer the funds from the payment credential to an instant cross-border electronic tokenised gifting system account associated with the giftee, wherein the at least a portion of the funds is received in the form of a tokenised gift; and
c. allow the giftee to purchase an item or service with the electronic tokenised gifting system using the funds received in the form of a tokenised gift.

18. A third-party transaction server for transferring funds to and from an electronic tokenised gifting system, the third-party transaction server comprising:
a file server configured to receive one or more electronic funds transfers from one or more payment credentials associated with an electronic tokenised gifting system account of a gifter;
a database that associates and stores details of the one or more received electronic funds transfers in the electronic tokenised gifting system account of the gifter;
a data backend communicatively coupled to the database, the data backend managing access and retrieval of the one or more received electronic funds transfers;
a gifter interface communicatively coupled to the data backend and to a gifter client device, the gifter interface configured to transfer at least a portion of funds associated with the one or more electronic funds transfers to an electronic tokenised gifting system account of a giftee;
a giftee interface communicatively coupled to the data backend that communicates to the giftee client device the receipt of the at least a portion of funds in the form of a tokenised gift in the electronic tokenised gifting system account of the giftee; and
wherein the giftee interface allows the recipient to make a purchase by transferring at least a portion of funds associated with the tokenised gift to an account associated with a merchant.

19. The third-party transaction server according to claim 18 wherein the gifter client device and the giftee client device comprise electronic devices selected from the group consisting of computers, mobile telephones, computing tablets or smart watches.

20. (canceled)

21. A method, in a communication environment including a third-party transaction server comprising a processor and a memory, for transferring funds to and from an electronic tokenised gifting system, the method comprising the steps of:
receiving, by the third-party transaction server, one or more electronic funds transfers from one or more payment credentials associated with an electronic tokenised gifting system account of a gifter;
generating, with the third-party transaction server, a funds transfer from the one or more payment credentials to an electronic tokenised gifting system account of a giftee;
determining, with the third-party transaction server, a monetary value of the funds transfer based on the location of the giftee;
deducting, with the third-party transaction server, the monetary value of the funds transfer from the one or more payment credentials of the gifter;
crediting in the form of a tokenised gift, with the third-party transaction server, the monetary value of the funds transfer to the electronic tokenised gifting system account of the giftee; and
communicating, with the third-party transaction server, the receipt of the tokenised gift to the giftee.
